(19) United States
(12) Patent Application Publication
(10) Pub. No.: US 2015/0267077 A1
(43) Pub. Date: Sep. 24, 2015

(54) COATED METAL SUBSTRATES AND METHODS OF PREPARING THEM

(71) Applicant: PPG INDUSTRIES OHIO, INC., CLEVELAND, OH (US)

(72) Inventors: Richard A. Janoski, SR., Pittsburgh, PA (US); Paul H. Lamers, Allison Park, PA (US); Kaliappa Ragunathan, Waxhaw, NC (US)

(73) Assignee: PPG INDUSTRIES OHIO, INC., CLEVELAND, OH (US)

(21) Appl. No.: 14/219,091

(22) Filed: Mar. 19, 2014

(51) Int. Cl. C09D 175/14

(52) U.S. Cl. CPC C09D 175/14

(57) ABSTRACT

The present invention is directed to a method for forming a composite coating on a bare, untreated metal substrate comprising:
(A) applying a first, waterborne coating composition directly to a surface of the bare substrate to form a first coating; and
(B) applying a second, transparent coating composition to the first coating formed in step (A) to form a secondary coating thereon and yielding a composite coating; wherein the first coating composition comprises an aqueous dispersion of polymeric microparticles having a core-shell morphology and having reactive functional groups, wherein the core of the polymeric microparticles is prepared from a monomer mixture comprising substantially hydrophobic ethylenically unsaturated monomers and wherein the shell of the polymeric microparticles comprises a polyurethane polymer containing acid functional groups and/or a polyurethane-urea polymer containing acid functional groups. Coated metal substrates prepared by this method are also provided.

### FIELD OF THE INVENTION

The present invention relates to methods of forming composite coatings on bare metal substrates and the resulting coated substrates.

### BACKGROUND OF THE INVENTION

There has long been an industry in the automotive and other vehicular after-markets providing custom artwork and decorative design work for consumers. Artists have painted scenes and other images on vehicular body panels using lacquers or refinish paints that cure under ambient conditions. Artwork may be done over existing OEM coatings, or more often one or more of the original coatings are removed from the vehicle substrate and the remaining surface is prepped before painting is done. Some artists have preferred to strip all the OEM coatings from the surface of the vehicle substrates and use the underlying metal surface as part of the design, etching an image into the bare metal or otherwise modifying the metal surface to provide a decorative design, followed by applying a clear coating to the metal surface to protect the metal from corrosion.

A drawback often encountered in these processes is poor adhesion of the available clear coating composition to the bare metal, particularly when the coating is waterborne, without using pretreatments or primers. Many artists want to avoid such undercoats because they detract from visibility of the metal surface, its color, uniformity of appearance, and its attendant metallic sheen through the coating layers.

It would be desirable to provide a method for forming a coating on a bare, untreated metal substrate that overcomes the drawbacks of the prior art.

### SUMMARY OF THE INVENTION

The present invention is directed to a method for forming a composite coating on a bare, untreated metal substrate comprising:

(A) applying a first, waterborne coating composition directly to a surface of the bare substrate to form a first coating; and
(B) applying a second, transparent coating composition to the first coating formed in step (A) to form a secondary coating thereon and yielding a composite coating; wherein the first coating composition comprises an aqueous dispersion of polymeric microparticles having a core-shell morphology and having reactive functional groups, wherein the core of the polymeric microparticles is prepared from a monomer mixture comprising substantially hydrophobic ethylenically unsaturated monomers and wherein the shell of the polymeric microparticles comprises a polyurethane polymer containing acid functional groups and/or a polyurethane-urea polymer containing acid functional groups. Coated metal substrates prepared by this method are also provided.

### DETAILED DESCRIPTION OF THE INVENTION

Other than in any operating examples, or where otherwise indicated, all numbers expressing quantities of Ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents, and are used interchangeably with the terms “at least one” and “one or more”, unless expressly and unequivocally limited to one referent.

The various embodiments and examples of the present invention as presented herein are each understood to be non-limiting with respect to the scope of the Invention.

As used in the following description and claims, the following terms have the meanings indicated below:

By “polymer” is meant a polymer including homopolymers and copolymers, and oligomers. By “composite material” is meant a combination of two or more differing materials.

The term “curable”, as used for example in connection with a curable composition, means that the indicated composition is polymerizable or cross linkable through functional groups, e.g., by means that include, but are not limited to, thermal (including ambient cure), catalytic, electron beam, chemical free-radical initiation, and/or photo-initiation such as by exposure to ultraviolet light or other actinic radiation.

The term “cure”, “cured” or similar terms, as used in connection with a cured or curable composition, e.g., a “cured composition” of some specific description, means that at least a portion of the polymerizable and/or crosslinkable components that form the curable composition is polymerized and/or crosslinked. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive groups occurs, the rate of reaction of the remaining unreacted reactive groups becomes progressively slower. The polymerizable composition can be subjected to curing conditions until it is at least partially cured. The term “at least partially cured” means subjecting the polymerizable composition to curing conditions, wherein reaction of at least a portion of the reactive groups of the composition occurs, to form a polymerizate. The polymerizable composition can also be subjected to curing conditions such that a substantially complete cure is attained and wherein further curing results in no significant further improvement in polymer properties, such as hardness.

By “ambient” is meant the condition of surroundings without adjusting the temperature, humidity or pressure. Ambient temperature typically ranges from 40 to 95° F. (about 4 to 35° C.), often 60 to 95° F. (about 15 to 35° C.).

The term “reactive” refers to a functional group capable of undergoing a chemical reaction with itself and/or other functional groups spontaneously or upon the application of heat or in the presence of a catalyst or by any other means known to those skilled in the art.

By “essentially free” of a material is meant that a composition has only trace or incidental amounts of a given material, and that the material is not present in an amount sufficient to affect any properties of the composition.

The present invention is drawn to a method for forming a composite coating on a bare, untreated metal substrate. Substrates to which compositions of the present invention may be applied include rigid metal substrates such as ferrous metals, aluminum, aluminum alloys, copper, and other metal and alloy substrates. The ferrous metal substrates used in the practice of the present invention may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used.

The shape of the metal substrate can be in the form of a sheet, plate, bar, rod or any shape desired, but it is usually in the form of an automobile part, such as a body, door, fender, hood or bumper. The thickness of the substrate can vary as desired.

Before depositing any coating compositions upon the surface of the substrate, it is common practice, though not necessary, to remove foreign matter or previously applied paints such as OEM coatings from the surface by thoroughly stripping, cleaning and degreasing the surface. When the substrate is not an existing vehicle part, such cleaning typically takes place after forming the substrate (stamping, welding, etc.) into an end-use shape. The surface of the substrate can be cleaned by physical or chemical means, or both, such as mechanically abrading the surface or cleaning/degreasing with commercially available alkaline or acidic cleaning agents which are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the substrate may be rinsed with deionized water or an aqueous solution of rinsing agents in order to remove any residue. The substrate can be air dried, for example, by using an air knife, by flashing off the water by brief exposure of the substrate to a high temperature or by passing the substrate between squeegee rolls. An advantage of the method of the present invention is that there is no need to apply any pretreatments such as phosphates or any primers such as etch primers to the bare surface of the substrate prior to application of the first waterborne coating composition.

In certain embodiments of the present invention, an initial step of forming a decorative design upon the surface of the substrate may be performed prior to applying the first coating composition in step (A). A design is typically formed by physically modifying the surface of the substrate, such as by mechanically or chemically etching, abrading, carving, brushing, hammering, stamping, or punching, to affect the topography of the metal surface and thus its appearance.

In step (A) of the process of the present invention, a first coating composition is applied directly to at least a portion of a surface of the substrate, in particular, the bare surface. The first coating composition comprises an aqueous dispersion of polymeric microparticles having a core-shell morphology and having reactive functional groups

The polymeric microparticles have a core/shell structure as noted above. The core (interior domain) and shell (surface domain) polymers may be covalently attached to each other, and the polymeric microparticles are formed by emulsion polymerization. Exemplary polymerization methods are demonstrated in the examples below. The core typically constitutes 30 to 70 percent by weight of the polymeric microparticle, while the shell usually makes up 70-30 percent by weight of the polymeric microparticle. Also, the core may be internally crosslinked through the use of monomers having multiple ethylenically unsaturated groups, such as ethylene glycol dimethacrylate. These internally crosslinking monomers are typically used in amounts up to 10 percent by weight, such as 3-10 percent by weight, based on the total weight of resin solids in the microparticles. The shell polymer is designed to be more polar than the core by including functional groups such as hydroxyl and acid groups. The shell polymer is typically formed from polyisocyanates and polyols, including acid functional polyols, in an amount sufficient to allow for dispersion of the polymeric microparticles in an aqueous medium.

Ethylenically unsaturated monomers used to prepare the core of the polymeric microparticles may include substantially hydrophobic monomers such as n-butyl (meth)acrylate, isobutyl (meth)acrylate, lauryl (meth)acrylate, 2-ethylhexyl (meth)acrylate, stearyl (meth)acrylate, and t-butyl (meth)acrylate, usually together with one or more other polymerizable ethylenically unsaturated monomers, including monomers having multiple ethylenically unsaturated groups such as ethylene glycol dimethacrylate and hexanediol diacrylate. By “substantially hydrophobic” is meant that the monomers have non-polar properties and have a tendency to interact with, be miscible with, or be dissolved by non-polar solvents such as alkanes and oils. Other useful alkyl esters of acrylic acid or methacrylic acid include aliphatic alkyl esters containing from 1 to 30, and usually 4 to 18 carbon atoms in the alkyl group. Non-limiting examples include methyl (meth)acrylate, ethyl (meth)acrylate, and n-butyl (meth)acrylate. Suitable other copolymerizable ethylenically unsaturated monomers include vinyl aromatic compounds such as styrene and vinyl toluene. Hydroxyl functional ethylenically unsaturated monomers such as hydroxyethyl (meth)acrylate and hydroxypropyl (meth)acrylate may also be used in amounts that do not significantly adversely affect the hydrophobicity of the core.

An exemplary monomer mixture used to prepare the core of the polymeric microparticles comprises hydroxyethyl methacrylate, n-butyl acrylate, and n-butyl methacrylate.

The shell of the polymeric microparticles comprises a polyurethane or polyurethane-urea polymer containing acid functional groups. Polyurethane polymers are prepared by reacting polyols with a polyisocyanate; in certain embodiments the OH/NCO equivalent ratio is greater than 1:1 so that free hydroxyl groups are present in the product. Suitable polyols include ethylene glycol, propylene glycol, butylene glycol, 1,6-hexylene glycol, neopentyl glycol, diethylene glycol, glycerol, trimethylol propane, and pentaerythritol. Polyols having dual functionality such as dimethylol propionic acid are also suitable, to incorporate acid functional groups into the resulting polyurethane. Polymeric polyols such as acrylic and polyester polyols may also be used. Such polymeric polyols may additionally have acid functional groups. The organic polyisocyanate which is used to prepare the polyurethane can be an aliphatic or an aromatic polyisocyanate or a mixture of the two. Diisocyanates are most often used, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate and polymethylene polyphenyl isocyanate. As noted above, the polyurethanes can be prepared with unreacted carboxylic acid groups, which upon neutralization with bases such as amines allows for dispersion into aqueous medium.

During formation of the core-shell polymers, the microparticles are produced in an aqueous medium. Neutralization of acid groups on the polymer may be done using, for example, inorganic bases such as ammonium hydroxide or amines such as dimethylethanolamine, diisopropanolamine, triethylamine, and the like. Effective dispersion techniques may include high shear mixing such as by homogenization, emulsification by use of an emulsifier, use of rotor/stator mixers, Cowles dispersers, or mixing a small volume of material with a conventional stirrer at a high agitation rate.

In embodiments of the present invention where the shell of the polymeric microparticles comprises a polyurethane-urea polymer, a polyurethane polymer may be prepared using reactants described above, but with an OH/NCO equivalent ratio less than 1:1 so that free isocyanate groups are present in the product. During production of the microparticles in the aqueous medium, the free isocyanate groups on the polyurethane polymer shell may be reacted with (poly)amines present in the aqueous medium to form urea linkages on the microparticles.

A “polyamine” is an amine with at least two amino groups. In certain embodiments, the polyamine is a diamine, and the amine nitrogens on the diamine are equally reactive; that is, all of the amine nitrogens are equally likely to react with another functional group. In certain other embodiments, the amine nitrogens of the diamine may be unequal in reactivity due to steric hindrance. Examples of suitable diamines include ethylene diamine, 1,2-diaminopropane, 1,5-diamino-2-methylpentane, 1,3-diaminopentane, 1,2-diaminocyclohexane, 1,6-diaminohexane, 1,11-diaminoundecane, 1,12-diaminododecane, 3-(cyclohexylamino)propylamine, 1-amino-3,3,5-trimethyl-5-aminomethylcyclohexane, (isophorone diamine (“IPDA”)), 4,4′-diaminodicyclohexylmethane, 3,3′-dimethyl-4,4′-diaminodicyclohexyl methane, 3,3′-[1,4-butanedylbis-(oxy)bis]-1-propanamine, methanediamine, and diamino functional polyether polyamines having aliphatically bound primary amino groups, examples of which include JEFFAMINE D-230, JEFFAMINE D-400, JEFFAMINE D-2000, and JEFFAMINE D-4000, available from Huntsman Corporation.

Suitable higher polyamines include primary and secondary triamines and/or tetraamines. In certain embodiments the amine is a triamine. Examples of suitable triamines include but are not limited to diethylene triamine, dipropylene triamine, bis(hexamethylene) triamine and triamino functional polyetherpolyamines having aliphatically bound primary amino groups (examples include JEFFAMINE T-403, T-3000, T-5000, available from Huntsman Corporation). For example, the amine can be an amine terminated (that is, an amine on each end, thus rendering the amine difunctional) polyethylene or polypropylene glycol, such as a polypropylene having an average molecular weight of 4000 or a polyethylene having an average molecular weight of 600. One skilled in the art will understand that these types of products are sold with a mixture of polymers having a relatively wide range of molecular weight, such as 4000+/−500 or 600+/−200 but that the average molecular weight is 4000 or 600. In other embodiments the amine can be a tetraamine or other higher functional amine. Monoamines may also be used to react with the isocyanate to generate urea linkages. Suitable monoamines include ethanolamine and diethanolamine.

In certain embodiments of the present invention, the first coating composition further comprises a crosslinking agent having functional groups reactive with functional groups on the polymeric microparticles. Suitable crosslinking materials may include, inter ala, polyisocyanates, polycarbodiimides, and mixtures thereof, as described below. The final resin solids content of the waterborne curable film-forming compositions is usually 25-30 percent by weight, often about 29 percent by weight, based on the total weight of resin solids in the curable film-forming composition.

Polyisocyanates suitable as crosslinking agents include any of those disclosed above as well as trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. Examples of suitable polycarbodiimides are disclosed in US 2011/0070374 and are available from Nesshimbo Chemical Co. under the trademark CARBODILITE.

In step (B) of the process of the present invention, a second, transparent coating composition is applied to at least a portion of the first coating applied in step (A), to form a secondary coating thereon, yielding a composite coating. The second coating composition used in the processes of the present invention comprises one or more film-forming resins. The compositions may be lacquers but are more often curable compositions. Curable compositions may further comprise a crosslinking agent.

Particularly useful polymeric film-forming resins are acrylic polymers, polyesters, including alkyds, and polyurethanes. Generally these polymers can be any polymers of these types made by any method known to those skilled in the art, particularly where the polymers are water dispersible or emulsifiable and preferably of limited water solubility.

Suitable acrylic polymers include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and usually 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate, vinyl laurate, vinyl pivalate, and vinyl dodecanoate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl)acrylamides and N-(alkoxymethyl)methacrylamides.

Beta-hydroxy ester functional monomers can be prepared from ethylenically unsaturated, epoxy functional monomers and carboxylic adds having from about 13 to about 20 carbon atoms, or from ethylenically unsaturated acid functional monomers and epoxy compounds containing at least 5 carbon atoms which are not polymerizable with the ethylenically unsaturated acid functional monomer.

Useful ethylenically unsaturated, epoxy functional monomers used to prepare the beta-hydroxy ester functional monomers include, but are not limited to, glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. Glycidyl acrylate and glycidyl methacrylate are especially suitable. Examples of carboxylic acids include, but are not limited to, saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, usually containing from 8 to 30 carbon atoms, such as butyl glycidyl ether, octyl glycidyl ether, phenyl glycidyl ether and para-(tertiary butyl) phenyl glycidyl ether. Frequently used glycidyl esters include those of the structure:

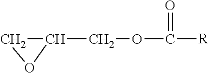

where R is a hydrocarbon radical containing from about 4 to about 26 carbon atoms. Often, R is a branched hydrocarbon group having from about 8 to about 10 carbon atoms, such as neopentanoate, neoheplanoate or neodecanoate. Suitable glycidyl esters of carboxylic acids include VERSATIC ACID 911 and CARDURA E, each of which is commercially available from Momentive Specialty Chemicals.

Carbamate functional groups can be included in the acrylic polymer by copolymerizing the acrylic monomers with a carbamate functional vinyl monomer, such as a carbamate functional alkyl ester of methacrylic acid. Alternatively, carbamate functionality may be introduced into the acrylic polymer by reacting a hydroxyl functional acrylic polymer with a low molecular weight carbamate functional material, such as can be derived from an alcohol or glycol ether, via a transcarbamoylation reaction. In this reaction, a low molecular weight carbamate functional material derived from an alcohol or glycol ether is reacted with the hydroxyl groups of the acrylic polyol, yielding a carbamate functional acrylic polymer and the original alcohol or glycol ether. The low molecular weight carbamate functional material derived from an alcohol or glycol ether may be prepared by reacting the alcohol or glycol ether with urea in the presence of a catalyst. Suitable alcohols include lower molecular weight aliphatic, cycloaliphatic, and aromatic alcohols such as methanol, ethanol, propanol, butanol, cyclohexanol, 2-ethylhexanol, and 3-methylbutanol. Suitable glycol ethers include ethylene glycol methyl ether and propylene glycol methyl ether. Propylene glycol methyl ether and methanol are most often used.

Amide functionality may be introduced to the acrylic polymer by using suitably functional monomers in the preparation of the polymer, or by converting other functional groups to amido-groups using techniques known to those skilled in the art. Likewise, other functional groups may be incorporated as desired using suitably functional monomers if available or conversion reactions as necessary.

The acrylic polymer may also comprise an aqueous dispersion of internally crosslinked polymeric microparticles having a core-shell morphology such as those described above.

Acrylic polymers can be prepared via aqueous emulsion polymerization techniques and used directly in the preparation of the coating compositions, or can be prepared via organic solution polymerization techniques with groups capable of salt formation such as acid or amine groups. Upon neutralization of these groups with a base or acid the polymers can be dispersed into aqueous medium. The acrylic polymers may alternatively be solventborne. Generally any method of producing such polymers that is known to those skilled in the art utilizing art recognized amounts of monomers can be used.

It is also possible to use a radiation curable coating composition, comprising ethylenically unsaturated monomers including any of those disclosed above and combinations thereof.

Besides acrylic polymers, the polymeric film-forming resin in the second coating composition may be an alkyd resin or a polyester. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used.

Useful alkyd resins include polyesters of polyhydroxyl alcohols and polycarboxylic acids chemically combined with various drying, semi-drying and non-drying oils in different proportions. Thus, for example, the alkyd resins are made from polycarboxylic acids such as phthalic acid, maleic acid, fumaric acid, isophthalic acid, succinic acid, adipic acid, azelaic acid, sebacic acid as well as from anhydrides of such acids, where they exist. The polyhydric alcohols which can be reacted with the polycarboxylic acid include 1,4-butanediol, 1,6-hexanediol, neopentyl glycol, ethylene glycol, diethylene glycol and 2,3-butylene glycol, glycerol, trimethylolpropane, pentaerythritol, sorbitol and mannitol.

The alkyd resins are produced by reacting the polycarboxylic acid and the polyhydric alcohol together with a drying, semi-drying or non-drying oil in proportions depending upon the properties desired. The oils are coupled into the resin molecule by esterification during manufacturing and become an integral part of the polymer. The oil is fully saturated or predominately unsaturated. When cast into films, fully saturated oils tend to give a plasticizing effect to the film, whereas predominately unsaturated oils tend to crosslink and dry rapidly with oxidation to give more tough and solvent resistant films. Suitable oils include coconut oil, fish oil, linseed oil, tung oil, castor oil, cottonseed oil, safflower oil, soybean oil, and tall oil. Various proportions of the polycarboxylic acid, polyhydric alcohol and oil are used to obtain alkyd resins of various properties as is well known in the art.

Carbamate functional groups may be incorporated into the polyester by first forming a hydroxyalkyl carbamate which can be reacted with the polyacids and polyols used in forming the polyester. The hydroxyalkyl carbamate is condensed with acid functionality on the polyester, yielding terminal carbamate functionality. Carbamate functional groups may also be incorporated into the polyester by reacting terminal hydroxyl groups on the polyester with a low molecular weight carbamate functional material via a transcarbamoylation process similar to the one described above in connection with the incorporation of carbamate groups into the acrylic polymers, or by reacting isocyanic acid with a hydroxyl functional polyester.

Other functional groups such as amide, thiol, urea, and thiocarbamate may be incorporated into the polyester or alkyd resin as desired using suitably functional reactants if available, or conversion reactions as necessary to yield the desired functional groups. Such techniques are known to those skilled in the art.

Polyurethanes can also be used in the second coating composition. Among the polyurethanes which can be used are polymeric polyols which generally are prepared by reacting the polyester polyols or acrylic polyols such as those mentioned above with a polyisocyanate such that the OH/NCO equivalent ratio is greater than 1:1 so that free hydroxyl groups are present in the product. The organic polyisocyanate which is used to prepare the polyurethane polyol can be an aliphatic or an aromatic polyisocyanate or a mixture of the two. Diisocyanates are most often used, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate and polymethylene polyphenyl isocyanate. As with the polyesters, the polyurethanes can be prepared with unreacted carboxylic acid groups, which upon neutralization with bases such as amines allows for dispersion into aqueous medium.

Terminal and/or pendent carbamate functional groups can be incorporated into the polyurethane by reacting a polyisocyanate with a polymeric polyol containing the terminal/pendent carbamate groups. Alternatively, carbamate functional groups can be incorporated into the polyurethane by reacting a polyisocyanate with a polyol and a hydroxyalkyl carbamate or isocyanic acid as separate reactants. Carbamate functional groups can also be incorporated into the polyurethane by reacting a hydroxyl functional polyurethane with a low molecular weight carbamate functional material via a transcarbamoylation process similar to the one described above in connection with the incorporation of carbamate groups into the acrylic polymer. Additionally, an isocyanate functional polyurethane can be reacted with a hydroxyalkyl carbamate to yield a carbamate functional polyurethane.

Other functional groups such as amide, thiol, urea, and thiocarbamate may be incorporated into the polyurethane as desired using suitably functional reactants if available, or conversion reactions as necessary to yield the desired functional groups. Such techniques are known to those skilled in the art.

As noted above, when the second coating composition used in the process of the present invention is curable, it may further comprise a crosslinking agent. Suitable crosslinking materials include aminoplasts, polyisocyanates, polyacids, anhydrides and mixtures thereof. Useful aminoplast resins are based on the addition products of formaldehyde with an amino- or amido-group carrying substance. Condensation products obtained from the reaction of alcohols and formaldehyde with melamine, urea or benzoguanamine are most common. While the aldehyde employed is most often formaldehyde, other similar condensation products can be made from other aldehydes, such as acetaldehyde, crotonaldehyde, acrolein, benzaldehyde, furfural, glyoxal and the like.

Condensation products of other amines and amides can also be used, for example, aldehyde condensates of triazines, diazines, triazoles, guanadines, guanamines and alkyl- and aryl-substituted derivatives of such compounds, including alkyl- and aryl-substituted ureas and alkyl- and aryl-substituted melamines. Non-limiting examples of such compounds include N,N′-dimethyl urea, benzourea, dicyandiamide, formaguanamine, acetoguanamine, glycoluril, ammeline, 3,5-diaminotriazole, triaminopyrimidine, and 2-mercapto-4,6-diaminopyrimidine.

The aminoplast resins often contain methylol or similar alkylol groups, and in most instances at least a portion of these alkylol groups are etherified by reaction with an alcohol. Any monohydric alcohol can be employed for this purpose, including methanol, ethanol, propanol, butanol, pentanol, hexanol, heptanol, as well as benzyl alcohol and other aromatic alcohols, cyclic alcohols such as cyclohexanol, monoethers of glycols, and halogen-substituted or other substituted alcohols such as 3-chloropropanol and butoxyethanol. Many aminoplast resins are partially alkylated with methanol or butanol.

Polyisocyanates that may be utilized as crosslinking agents can be prepared from a variety of isocyanate-containing materials. The polyisocyanate may be a blocked polyisocyanate. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used. Examples of suitable blocking agents include those materials which would unblock at elevated temperatures such as lower aliphatic alcohols including methanol, oximes such as methyl ethyl ketoxime, lactams such as caprolactam and pyrazoles such as dimethyl pyrazole.

Examples of polycarboxylic acids that are suitable for use as a crosslinking agent include those described in U.S. Pat. No. 4,681,811, at column 6, line 45 to column 9, line 54. Suitable polyanhydrides include those disclosed in U.S. Pat. No. 4,798,746, at column 10, lines 16-50, and in U.S. Pat. No. 4,732,790, at column 3, lines 41 to 57. The cited portions of each of these patents are incorporated herein by reference.

The most suitable crosslinking agents are those that cure at ambient temperatures.

The coating compositions used in the process of the present invention may contain adjunct ingredients conventionally used in coating compositions. Optional ingredients such as, for example, plasticizers, surfactants, thixotropic agents, anti-gassing agents, organic cosolvents, flow controllers, anti-oxidants, UV light absorbers and similar additives conventional in the art may be included in the composition. These ingredients are typically present at up to about 40% by weight based on the total weight of resin solids.

The second coating composition is transparent; the first coating composition may also be transparent. The term ‘transparent’, as used for example in connection with a substrate, film, material and/or coating, means that the indicated substrate, coating, film and/or material has the property of transmitting light without appreciable scattering so that objects lying beyond are entirely visible. As used herein, transparent articles typically demonstrate a light transmittance of at least 80%, often at least 90%, and exhibit a haze value of less than 5 percent, e.g., less than 1 percent or less than 0.5 percent, when the haze value is measured at 550 nanometers by, for example, a Haze Gard Plus Instrument.

Each of the coating compositions described above may contain colorants conventionally used in surface coatings. As used herein, the term “colorant” means any substance that imparts color and/or other visual effect to the composition. In certain embodiments, the colorants are used in an amount to impart the desired visual effect while maintaining transparency of the coating. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or Inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (‘DPPBO red’), titanium dioxide, carbon black and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference in its entirety. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference in its entirety, and U.S. Provisional Application No. 60/482,167 filed Jun. 24, 2003.

Example special effect compositions that may be used in the coating compositions include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference in its entirety. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coatings of the present invention. Photochromic and/or photosensitive compositions can be activated by exposure to radiation of a specified wavelength. When the composition becomes energized, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In certain embodiments, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004.

In general, the colorant can be present in the coating composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

In step (A) of the process of the present invention, a first coating composition is applied to at least a portion of a surface of the substrate. Each coating composition may be applied to the substrate by one or more of a number of methods including spraying, rolling, curtain coating, dipping/immersion, brushing, or flow coating, but they are most often applied by spraying for the sake of appearance. The usual spray techniques and equipment for air spraying and electrostatic spraying and either manual or automatic methods can be used. The first coating composition is applied in an amount to yield a dry film thickness of 5 to 30 microns, such as 5 to 15 microns or 5 to 10 microns.

After forming a film of the first coating layer on the substrate, the first coating layer can be given a drying step in which water and solvent are driven out of the coating film by heating or an air drying period at room temperature before application of the second coating composition. Suitable drying conditions may depend, for example, on the ambient temperature and humidity. Alternatively, the second coating composition may be applied immediately to the first without drying the first coating. The second coating composition may be applied to at least a portion of the uncured first coating formed in step (A) prior to substantially curing or drying the first coating, forming a substantially uncured secondary coating thereon. Such a coating process is often referred to as “wet-on-wet”. The second coating layer typically has a dry film thickness of 10 to 25 microns.

After application of the second coating composition to the first, forming a composite coating on the substrate, the process of the present invention may comprise an additional step (C) wherein the coated substrate may be held at a temperature and for a time sufficient to substantially cure any curable coating compositions that have been applied to the substrate. Such cure protocols typically include a temperature range of ambient to 180° C. for a time of 10 to 120 minutes, or even up to 24 hours for ambient cure.

Coated substrates prepared in accordance with the method of the present invention demonstrate improved adhesion to bare, untreated metal substrates, compared to coating compositions used in similar processes of the prior art. The coated substrates also demonstrate sandability, allowing for application of subsequent coating layers without loss of appearance.

The following examples are intended to illustrate various embodiments of the invention, and should not be construed as limiting the invention in any way. Unless otherwise indicated, all parts are by weight.

### EXAMPLES

### Example A

A polyesterdiol was prepared as follows:

To a 4-necked round bottom flask fitted with a stirrer, gas inlet, packed column, thermometer, and condenser was added 1652 g of 1,6-hexanediol, 876 g of adipic acid, 1008 g of methylhexahydrophthalic anhydride, 3.2 g of butylstannoic acid and 3.2 g of triphenyl phosphite. The reaction mixture was heated in stages under an inert N₂ atmosphere to a maximum temperature of 230° C. while ensuring that the head temperature did not exceed 100° C. When the acid value reached 10, a Dean Stark trap was fitted to the flask and 100 g of toluene was added to facilitate removal of the final amounts of water. The reaction was held until the residual acid value was <2 after which time the reaction was cooled to 180° C. and vacuum was applied for 30 minutes. The resulting viscous resin had a solids of 99%, and a theoretical OH value of 70.

### Example B

A urethane acrylate was prepared as follows:

To a 4-necked round bottom flask fitted with a stirrer, gas inlet for air sparge, addition funnel, thermometer and condenser was added 69.7 g of dimethylolpropionic acid, 417.6 g of the polyesterdiol of Example A, 0.8 g of triphenylphosphite, 1 g of ionol, 0.8 g of dibulyltin dilaurate, and 50 g of methylethyl ketone. The mixture was heated to 80° C. for 30 minutes to dissolve the dimethylolpropionic acid. 33.8 g of hydroxyethyl methacrylate and 316.5 g of butyl acrylate were then added and the mixture was cooled to 50° C. 230.9 g of isophorone diisocyanate was then added via addition funnel over 20 minutes while ensuring the temperature did not exceed 70° C. The addition funnel was then rinsed with 30 g of butyl acrylate, and the mixture was heated to 100° C. After 30 minutes a Dean Stark trap was installed and the methylethyl ketone was removed. The reaction was held for 2 hours at 100° C. 19.8 g of glycerine was then added and the reaction was held for 1 hour. After this time, infrared analysis showed complete consumption of isocyanate. The solution was cooled to 90° C. and 36.8 g of dimethylethanolamine was added. 984 g of the above solution was then dispersed into 1473 g deionized water that was preheated to 70° C. in a 4-necked round bottom flask under air atmosphere. The ensuing small particle size, waterborne dispersion had a solids level of 28.8%, a viscosity of 240 cps, and a pH value of 6.7.

### Example C

A urethane acrylate was prepared as follows:

To a 4-necked round bottom flask fitted with a stirrer, gas inlet for N₂ sparge, thermometer and condenser was added 600 g of the urethane dispersion of Example B, 300 g of deionized water, 84 g of butyl methacrylate and 12 g of butyl acrylate The solution was heated to 35° C. and sparged with N₂ for 30 minutes to remove dissolved oxygen. A solution of 0.0054 g of ferrous ammonium sulfate in 5 g deionized water was then added followed by the addition of a solution of 0.52 g isoascorbic acid, 0.24 g dimethylethanolamine in 10 g deionized water. The solution was stirred for 5 minutes and ˜60% of a solution of 2.37 g of a 35% hydrogen peroxide solution diluted in 15 g deionized water added over ˜5 minutes. A rapid exotherm with a maximum temperature of 54° C. ensued. When the exotherm began to subside, the remainder of the hydrogen peroxide solution was added over 2 minutes and the reaction was heated to 65° C. and held at this temperature for 30 minutes. After cooling, a solution of 2.4 g of dimethylethanolamine in 10 g of deionized water was added. The nearly transparent dispersion had a solids content of 32%, a viscosity of 100 cps, and a pH value of 8.0.

### Example D

A urethane-urea acrylate was prepared as follows:

To a 4-necked round bottom flask fitted with a stirrer, gas inlet for air sparge, addition funnel, thermometer and condenser was added 119.2 g of dimethylolpropionic acid, 355.69 g of polytetrahydrofuran 1000 (TERATHANE 1000, available from Invista), 1.1 g of triphenylphosphite, 2.2 g of ionol, and 54 g of triethylamine. The mixture was heated to 125° C. and then 27.8 g of hydroxyethyl methacrylate, 319.2 g of butyl acrylate and 48.4 g of butyl methacrylate were then added while the mixture was cooled to 65° C. 558.9 g of DESMODUR W (available from Bayer Material Science) was then added via addition funnel over 10 minutes. The addition funnel was then rinsed with 55.6 g of butyl methacrylate, and the mixture was held at 70° C. until the NCO equivalent weight was >970. To produce the aqueous dispersion, 1337 g of the above prepolymer was dispersed into a mixture of 2086 g of deionized water, 20.2 g diethanolamine, 26.9 g ethylene diamine, 19.7 g of dimethylethanolamine that had been warmed to 60° C. prior to addition of the prepolymer. The ensuing small particle size, waterborne dispersion had a solids level of 30%, a viscosity of 490 cps, and a pH value of 7.2

### Example E

A urethane-urea acrylate was prepared as follows:

To a 4-necked round bottom flask fitted with a stirrer, gas inlet for N₂ sparge, thermometer and condenser was added 901 g of deionized water, 5.7 g of a 1% solution of ferrous ammonium sulfate, 2.6 g t-butyl hydroperoxide, 257 g of PROPASOL B (available from Union Carbide Corp.). 1925 of the above dispersion was added over 5 minutes with stirring, and a monomer solution of 221.5 g butyl methacrylate, 431.3 g methyl methacrylate, 93.3 g butyl acrylate was added over 5 minutes with stirring. The ensuing solution was adjusted to 30° C. and stirred for 15 minutes. A solution of 2.6 g of sodium metabisulfite in 183.4 g deionized water was then added over 30 minutes and the exotherm was monitored. A peak exotherm of 67° C. was reached 10 minutes into the addition. After the addition was complete, the solution was cooled to ambient temperature. The nearly transparent dispersion had a solids content of 37%, a viscosity of 1400 cps, and a pH value of 7.4.

### Formulation Examples

A clear basecoat composition was prepared from the following mixture of ingredients in the order listed:

| Component | Percent by Weight |
|---|---|
| Combine under agitation: | |
| Urethane Acrylate of Example C | 53.452 |
| Polyester Urethane¹ | 4.751 |
| Deionized water | 5.456 |
| 2-butoxyethanol | 5.702 |
| Adjust pH to 8.3-8.5: | |
| Dimethylethanolamine, 10% in | 0.380 |
| water | |
| BYK 333² | 0.038 |
| Stir ten minutes and then add: | |
| SURFYNOL 104E³ | 0.285 |
| 2-ethylhexanol | 1.901 |
| AQUAFLOW NLS 210 | 1.520 |
| Intermediate⁴ | |
| Deionized water | 26.516 |
| TOTAL | 100.000 |

¹polyester urethane resin comprising: 11% polyester CAS No. 40374-66-1, 5.2% adipic acid dihydrazide, 6.4% dimethanol propionic acid, 53.5% trimethylene ether, and the remainder isophorone diisocyanate
²available from BYK Chemie, USA.
³Surfactant commercially available from Air Products and Chemicals, Inc.
⁴25% AQUAFLOW NLS 210, rheology modifier available from Ashland Specialty Ingredients/19% Diethylene glycol monobutyl ether/56% deionized water

The first coating composition was spray applied in an ambient environment onto 4-inch by 12-inch (10 cm by 30 cm) cold roll steel panels. The substrate panels were obtained from ACT Test Panels, LLC of Hillsdale, Mich. No pretreatment was used. The coating composition was applied in two coats, with a flash between coats, and then flashed at ambient temperature for 15 minutes. The film thickness was approximately 0.55 mils (14 microns). A 2K Refinish clear coat commercially available from PPG Industries, Inc. as DC4000 was then applied over ½ of the coated panel in two coats with a flash between coats. The clear coated panels were allowed to flash for 10 minutes at ambient conditions and baked for 30 minutes at 140° F. (60° C.). The film thickness was approximately 2.0 mils (50 microns).

Appearance and physical properties were measured on the coated panels.

Cross hatch adhesion as per Global Test method is done on the clear coated and non-clear coated side. Results show 100% adhesion on both sides. Adhesion is tested 24 hours after application and various times thereafter.

Therefore, we claim:

1. A method for forming a composite coating on a bare, untreated metal substrate comprising:
(A) applying a first, waterborne coating composition directly to a surface of the bare substrate to form a first coating; and
(B) applying a second, transparent coating composition to the first coating formed in step (A) to form a secondary coating thereon and yielding a composite coating; wherein the first coating composition comprises an aqueous dispersion of polymeric microparticles having a core-shell morphology and having reactive functional groups, wherein the core of the polymeric microparticles is prepared from a monomer mixture comprising substantially hydrophobic ethylenically unsaturated monomers and wherein the shell of the polymeric microparticles comprises a polyurethane polymer containing acid functional groups and/or a polyurethane-urea polymer containing acid functional groups.

2. The method according to claim 1, further comprising an initial step of forming a decorative design upon the surface of the substrate prior to applying the first coating composition of step (A), wherein the design is formed by physically modifying the surface of the substrate to affect the topography of the metal surface.

3. The method according to claim 1, wherein the substrate comprises a ferrous metal.

4. The method according to claim 1, wherein the first coating composition is transparent.

5. The method according to claim 4, wherein the first and/or second coating composition comprises a colorant.

6. The method according to claim 1, wherein the first and/or second coating composition comprises a colorant.

7. The method according to claim 1, wherein the first coating composition further comprises a crosslinking agent having functional groups reactive with functional groups on the polymeric microparticles.

8. The method according to claim 1, wherein the monomer mixture includes one or more of n-butyl (meth)acrylate, isobutyl (meth)acrylate, lauryl (meth)acrylate, 2-ethylhexyl (meth)acrylate, stearyl (meth)acrylate, hydroxypropyl (meth)acrylate, ethylene glycol dimethacrylate, hexanediol diacrylate, t-butyl (meth)acrylate, and styrene.

9. The method of claim 1, wherein the first coating layer is applied over the substrate to yield a dry film thickness of 5 to 30 microns.

10. The method according to claim 1, further comprising: (C) holding the substrate at a temperature and for a time sufficient to substantially cure any curable coating compositions applied to the substrate.

11. A coated metal substrate comprising:
A) a bare, untreated metal substrate;
B) a first, waterborne coating composition applied directly to a surface of the bare substrate forming a first coating; and
C) a second, transparent coating composition applied to the first coating forming a secondary coating thereon; wherein the first coating composition comprises an aqueous dispersion of polymeric microparticles having a core-shell morphology and having reactive functional groups, wherein the core of the polymeric microparticles is prepared from a monomer mixture comprising substantially hydrophobic ethylenically unsaturated monomers and wherein the shell of the polymeric microparticles comprises a polyurethane polymer containing acid functional groups and/or a polyurethane-urea polymer containing acid functional groups.

12. The coated metal substrate according to claim 11, wherein the surface of the substrate has a decorative design thereon, formed prior to applying the first coating composition, and wherein the design is formed by physically modifying the surface of the substrate to affect the topography of the metal surface.

13. The coated metal substrate according to claim 11, wherein the substrate comprises a ferrous metal.

14. The coated metal substrate according to claim 11, wherein the first coating composition is transparent.

15. The coated metal substrate according to claim 14, wherein the first and/or second coating composition comprises a colorant.

16. The coated metal substrate according to claim 11, wherein the first and/or second coating composition comprises a colorant.

17. The coated metal substrate according to claim 11, wherein the first coating composition further comprises a crosslinking agent having functional groups reactive with functional groups on the polymeric microparticles.

18. The coated metal substrate according to claim 11, wherein the monomer mixture includes one or more of n-butyl (meth)acrylate, isobutyl (meth)acrylate, lauryl (meth)acrylate, 2-ethylhexyl (meth)acrylate, stearyl (meth)acrylate, hydroxypropyl (meth)acrylate, ethylene glycol dimethacrylate, hexanediol diacrylate, t-butyl (meth)acrylate, and styrene.

19. The coated metal substrate according to claim 11, wherein the first coating layer is applied over the substrate to yield a dry film thickness of 5 to 30 microns.
